(19) United States
(12) Patent Application Publication
(10) Pub. No.: US 2022/0107495 A1
(43) Pub. Date: Apr. 7, 2022

(54) LIQUID LENSES AND LIQUID LENS ARTICLES WITH LOW REFLECTIVITY ELECTRODE STRUCTURES

(71) Applicant: Corning Incorporated, Coming, NY (US)

(72) Inventors: Robert Alan Bellman, Ithaca, NY (US); Raymond Miller Karam, Santa Barbara, CA (US); Marie Bernadette O'Regan, Santa Barbara, CA (US)

(21) Appl. No.: 17/424,921

(22) PCT Filed: Jan. 20, 2020
(86) PCT No.: PCT/US2020/014248

§ 371 Date: Jul. 22, 2021

Related U.S. Application Data
(60) Provisional application No. 62/796,373, filed on Jan. 24, 2019.

(51) Int. Cl. G02B 26/00; G02B 5/00; G02B 3/12

(52) U.S. Cl. CPC G02B 26/005; G02B 3/12; G02B 5/003

(57) ABSTRACT

A liquid lens article that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises at least two metal oxide layers and at least one metal layer, each metal layer between two of the metal oxide layers. In addition, the electrode can comprise a sheet resistance from about 5 Ω/sq to about 0.5 Ω/sq.

### CROSS-REFERENCE TO RELATED APPLICATIONS

This application claims the benefit of priority under 35 U.S.C. § 119 of U.S. Provisional Application No. 62/796,373, filed Jan. 24, 2019, the content of which is incorporated herein by reference in its entirety.

### FIELD OF THE DISCLOSURE

The disclosure relates to liquid lenses and liquid lens articles with low reflectivity electrode structures and, more particularly, to such liquid lenses and articles with electrode structures suitable for laser bonding process steps.

### BACKGROUND

Liquid lenses generally include two immiscible liquids disposed within a chamber. Varying an electric field applied to the liquids can vary the wettability of one of the liquids relative to walls of the chamber, which has the effect of varying the shape of a meniscus formed between the two liquids. Further, in various applications, changes to the shape of the meniscus can drive controlled changes to the focal length of the lens.

One challenge associated with manufacturing a liquid lens is forming a hermetic bond between the substrates of the lens. These substrates may be made from glass, glass-ceramics, ceramics, polymers, and other high modulus materials, which present difficulties in forming reliable, hermetic bonds. Further, the bonding steps are often conducted in a wet environment in close proximity to the liquids employed by the lens for its optical function. In addition, the substrates of the liquid lens also comprise conductive electrodes, which are often dissimilar in composition and structure relative to the substrates.

Accordingly, there is a need for liquid lens and liquid lens article configurations suitable for substrate bonding, particularly laser bonding processes.

### SUMMARY OF THE DISCLOSURE

According to some aspects of the present disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises at least two metal oxide layers and at least one metal layer, each metal layer between two of the metal oxide layers.

According to other aspects of the present disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises at least two metal oxide layers and at least one metal layer, each metal layer between two of the metal oxide layers. In addition, the electrode comprises a sheet resistance from about 5 Ω/sq to about 0.5 Ω/sq.

According to further aspects of the present disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises at least two conductive dielectric layers and at least one metal layer, each metal layer between two of the conductive dielectric layers. In addition, the electrode comprises a sheet resistance from about 5 Ω/sq to about 0.5 Ω/sq and each of the at least two conductive dielectric layers of the absorber structure comprises a resistivity of less than about 1E-2 Ω·cm and a band gap of at least about 3.5 eV.

According to other aspects of the present disclosure, a liquid lens is provided that includes: a first substrate; an electrode disposed on a primary surface of the first substrate and comprising an electrically conductive structure disposed on the primary surface of the first substrate and an optical absorber structure disposed on the electrically conductive structure; a second substrate disposed on the absorber structure of the electrode; a bond defined at least in part by the electrode, wherein the bond hermetically seals the first substrate and the second substrate; a cavity defined at least in part by the bond; and a first liquid and a second liquid disposed within the cavity. Further, the electrode comprises a reflectivity minimum of about 3% or less at a visible wavelength within a range of 390 nm to 700 nm, and a reflectivity of about 25% or less at an ultraviolet wavelength within a range of 100 nm to 400 nm. The absorber structure comprises at least two metal oxide layers and at least one metal layer, each metal layer between two of the metal oxide layers. In addition, the first liquid and the second liquid are substantially immiscible such that an interface between the first liquid and the second liquid defines a lens of the liquid lens.

According to additional aspects of the present disclosure, a liquid lens is provided that includes: a first substrate; an electrode disposed on a primary surface of the first substrate; a second substrate disposed on the electrode; a bond defined at least in part by the electrode, wherein the bond hermetically seals the first substrate and the second substrate; a cavity defined at least in part by the bond; and a first liquid and a second liquid disposed within the cavity. The first liquid and the second liquid are substantially immiscible such that an interface between the first liquid and the second liquid defines a lens of the liquid lens. Further, the electrode comprises a reflectivity minimum of about 3% or less at a visible wavelength within a range of 390 nm to 700 nm, a reflectivity of about 25% or less at an ultraviolet wavelength within a range of 100 nm to 400 nm, and a sheet resistance from about 5 Ω/sq to about 0.5 Ω/sq. In addition, the bond comprises an optical transmittance of at least about 70% at an infrared wavelength within a range of 800 nm to 1.7 μm.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic, cross-sectional view of embodiments of a liquid lens;

FIG. 2 is an enlarged view of the liquid lens depicted in FIG. 1 showing a liquid lens article comprising a first substrate, a second substrate, an electrode between the substrates and a bond defined at least in part by the electrode, according to embodiments;

FIGS. 2A-2C are schematic, cross-sectional views of embodiments of a liquid lens article with an electrode disposed on a first substrate with varying configurations;

FIG. 3A is a plot of reflectance spectra of an indium tin oxide (ITO) film sputtered on a silicon wafer, according to an embodiment;

FIG. 3B is a plot of refractive index as a function of wavelength of the ITO film/silicon wafer arrangement of FIG. 3A;

FIG. 4 is a plot of reflectance spectra for a Cr/ITO/Cr/ITO electrode on a glass substrate, according to an embodiment;

FIGS. 4A-4C are reflectance spectra of the Cr/ITO/Cr/ITO electrode depicted in FIG. 4 for configurations with varying thicknesses of the layers of the electrode, according to embodiments;

FIG. 5 is a plot of reflectance spectra for a Ni/ITO/Cr/ITO electrode on a glass substrate, according to an embodiment;

FIG. 6 is a plot of reflectance spectra for a Mo/ITO/Mo/ITO electrode on a glass substrate, according to an embodiment;

FIG. 7 is a plot of reflectance spectra for a Cr/Au/Cr/ITO/Cr/ITO electrode on a glass substrate, according to an embodiment;

FIG. 8 is a plot of reflectance spectra for a Ti/Cu/IGZO/Ti/IGZO electrode on a glass substrate, according to an embodiment; and

FIGS. 9A-9C are box plots of measured parameters of liquid lenses fabricated with a comparative Cr/CrOxNy electrode and the Cr/ITO/Cr/ITO configuration depicted in FIG. 4, according to embodiments.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the terms “reflectance” and “reflectivity” are synonymous and used interchangeably in this disclosure.

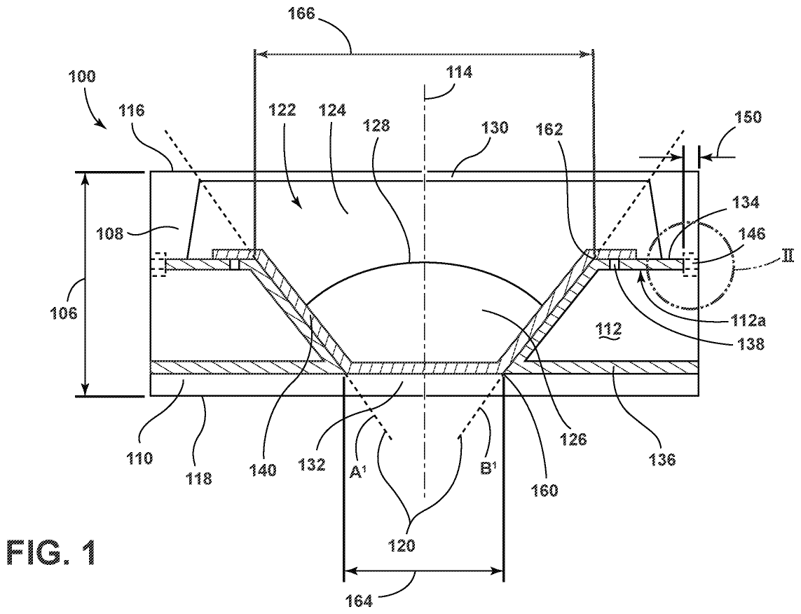

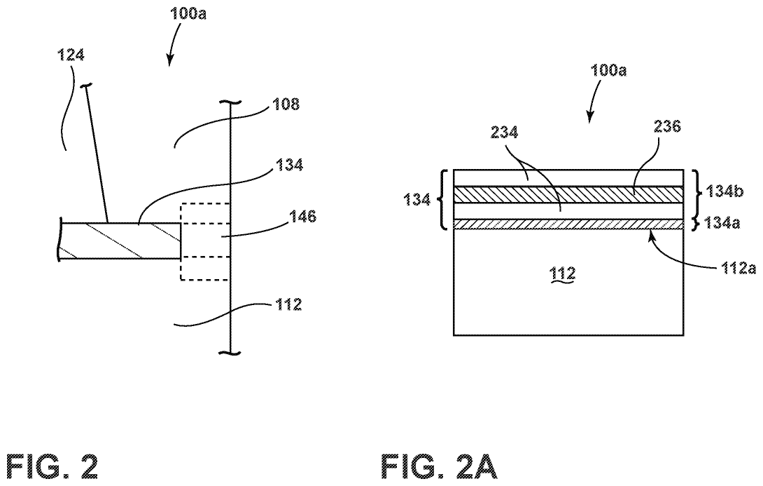

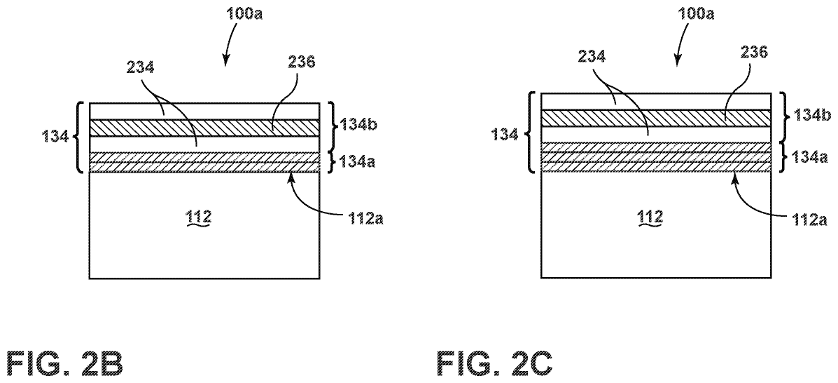

In various embodiments of the disclosure, a liquid lens article is provided that includes a first substrate and an electrode disposed on a primary surface of the substrate (e.g., the liquid lens articles 100a depicted in FIGS. 2A-2C and detailed below). The electrode can include an electrically conductive structure disposed on the primary surface of the substrate and an optical absorber structure disposed on the electrically conductive structure. The electrode can be characterized by a reflectivity minimum of about 3% or less at a visible wavelength, and a reflectivity of about 25% or less at an ultraviolet wavelength. The electrode can also be characterized by a sheet resistance from about 5 Ω/sq to about 0.5 Ω/sq. Further, the absorber structure can comprise at least two metal oxide layers and at least one metal layer, each metal layer between two of the metal oxide layers. The absorber structure can also comprise at least two conductive dielectric layers and at least one metal layer, each metal layer between two of the conductive dielectric layers. The conductive dielectric layers can be characterized by a resistivity of less than about 1E-2 Ω·cm and a band gap of at least about 3.5 eV. In addition, some of the liquid lens article embodiments further include a second substrate disposed on the optical absorber structure of the electrode and a bond defined at least in part by the electrode and the substrates (e.g., the liquid lens article 100a depicted in FIG. 2A and detailed below). Further, the disclosure includes liquid lens configurations that incorporate these liquid lens articles (e.g., the liquid lens 100 depicted in FIG. 1 and detailed below). Such liquid lens configurations can also include an additional electrode and third substrate (e.g., a second electrode 136 and third substrate 110 depicted in FIG. 1 and detailed below), in some implementations.

The electrode structures detailed in this disclosure can enable, or otherwise positively influence, the achievement of various technical requirements and performance aspects of the devices employing the implementations of the liquid lens articles and lenses of the disclosure. Among these technical considerations, the electrodes should provide enough current carrying capability to allow for the induced voltage variations for proper operation of the liquid lens device. Higher current density carrying capabilities in the electrodes can be advantageous, however, to enable the patterning of resistance-based heaters from the electrode that can heat the device to improve liquid lens operation under sub-zero temperature evolutions. The liquid lens device should also be configured to suppress optical reflections in the cone containing the liquids of the liquid lens. As such, the electrodes of the disclosure are configured to have low reflectivity in the visible wavelength regime to suppress stray optical reflections within the core for optimal liquid lens device performance. Another technical consideration is that the sealing of the substrates of the liquid lens can be limited by the materials and configuration of the electrodes. In view of this consideration, the electrodes of the disclosure can enable the laser bonding of the substrates by exhibiting a low reflectivity in the ultraviolet wavelength regime, particularly at those wavelengths of the laser employed by the bonding process. Further, the electrodes of the disclosure can facilitate laser dicing of liquid lens devices from an array of such devices. In particular, the electrodes of the disclosure are amenable to a laser bond formed from the substrates and the electrode that is substantially transparent to the wavelength of infrared lasers employed to dice the individual liquid lens devices from an array of such devices. Interconnection performance is another important technical consideration of liquid lens devices. The electrodes of the disclosure have the advantage of not requiring additional etching or patterning process steps prior to the development of an electrical connection to the electrode. In contrast, conventional liquid lens electrodes with non-conductive topmost layers need to be etched or patterned prior to interconnection to reveal and expose the conductive layers or materials within the electrode.

Referring to FIG. 1, a liquid lens 100 is provided that includes: a first substrate 112 (also referred herein as “intermediate layer 112”); an electrode 134 disposed on a primary surface 112a of the first substrate 112; and a second substrate 108 (also referred herein as a “first outer layer 108”) disposed on the electrode 134. The liquid lens 100 also includes a bond 146 defined at least in part by the electrode 134, wherein the bond 146 hermetically seals the first substrate 112 and the second substrate 108. The liquid lens 100 further includes a cavity 122 defined at least in part by the bond 146; and a first liquid 124 and a second liquid 126 disposed within the cavity 122. In addition, the first liquid 124 and the second liquid 126 are substantially immiscible such that an interface 128 between the first liquid 124 and the second liquid 126 defines a lens (e.g., by refracting image light passing through the interface 128) of the liquid lens 100. Further, the electrode 134 is characterized by a reflectivity minimum of about 3% or less at a visible wavelength within a range of 390 nm to 700 nm, a reflectivity of about 25% or less at an ultraviolet wavelength within a range of 100 nm to 400 nm, and a sheet resistance from about 5 Ω/sq to about 0.5 Ω/sq. In addition, the bond 146 can be characterized by an optical transmittance of at least about 70% at an infrared wavelength within a range of 800 nm to 1700 nm. In some implementations of the liquid lens 100, the electrode 134 can be characterized by a reflectivity of about 10% or less at the ultraviolet wavelength within the range of 100 nm to 400 nm. In further implementations of the liquid lens 100, the electrode 134 can be characterized by a reflectivity minimum of about 1% or less at the visible wavelength within the range of 390 nm to 700 nm, and a reflectivity of about 5% or less at the ultraviolet wavelength within the range of 100 nm to 400 nm.

According to an exemplary implementation of the liquid lens 100 of the disclosure depicted in FIG. 1, the electrode 134 comprises an electrically conductive structure 134a (see FIGS. 2A-2C) disposed on the primary surface 112a of the first substrate 112 and an optical absorber structure 134b (see FIGS. 2A-2C) disposed on the electrically conductive structure 134a. Further, the absorber structure 134b comprises at least two metal oxide layers 234 and at least one metal layer 236 (see FIGS. 2A-2C), each metal layer 236 between two of the metal oxide layers 234. In some embodiments, each of the electrically conductive structure 134a and the at least one metal layer 236 of the optical absorber structure 134b can be fabricated from a metal or metal alloy that includes Cr, Mo, Au, Ag, Ni, Ti, Cu, Al, a Ni/Au alloy, a Au/Si alloy, Zr, V, a Cu/Ni alloy, or combinations thereof. Each of the at least two metal oxide layers 234 of the absorber structure 134b can be fabricated from a transparent conductive oxide (TCO) including but not limited to indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), or combinations thereof. According to an implementation of this liquid lens 100, each of the at least two metal oxide layers 234 has a thickness from about 20 nm to about 60 nm, each of the at least one metal layer 236 of the absorber structure 134b has a thickness from about 2 nm to about 20 nm, and the electrically conductive structure 134a has a thickness from about 30 nm to about 200 nm.

In some embodiments, the liquid lens 100 has an optical axis 114. The first outer layer 108 has an external surface 116. In embodiments, the liquid lens 100 has a third substrate 110 (also referred herein as “second outer layer 110”), which likewise has an external surface 118. The thickness 106 of the liquid lens 100 is defined by the distance between the external surface 116 of the first outer layer 108 and the external surface 118 of the second outer layer 110. The intermediate layer 112 (also referred herein as the “first substrate 112”) has a through hole 120 denoted by dotted lines A′ and B′. The optical axis 114 extends through the through hole 120. The through hole 120 is rotationally symmetric about the optical axis 114, and can take a variety of shapes, for example, as set forth in U.S. Pat. No. 8,922,901, which is hereby incorporated by reference in its entirety. The first outer layer 108, the second outer layer 110, and the through hole 120 of the intermediate layer 112 define a cavity 122. In other words, the cavity 122 is disposed between the first outer layer 108 and the second outer layer 110, and within the through hole 120 of the intermediate layer 112. In implementations of the liquid lens 100, the first outer layer 108, the second outer layer 110, and the intermediate layer 112 are all transparent (e.g., with an optical transmittance of at least 70%) to the wavelength of a laser (e.g., 1060 nm for an infrared CO₂ laser) employed for liquid lens dicing operations (e.g., to dice or otherwise separate a liquid lens 100 from a plurality of liquid lenses 100). A small gap (not illustrated) may separate each of the first outer layer 108, the second outer layer 110, and the intermediate layer 112 from their adjacent layer. The through hole 120 has a narrow opening 160 and a wide opening 162. The narrow opening 160 has a diameter 164. The wide opening 162 has a diameter 166. In some embodiments, the diameter 166 of the wide opening 162 is greater than the diameter 164 of the narrow opening 160.

Referring again to FIG. 1, the liquid lens 100 further includes a first liquid 124 and a second liquid 126 disposed within the cavity 122. Because of the properties of the first liquid 124 and the second liquid 126, the first liquid 124 and the second liquid 126 separate from one another at the interface 128. In embodiments, the first liquid 124 and second liquid 126 are non-miscible or substantially non-miscible. The first liquid 124 can be a polar liquid or a conducting liquid. Additionally, or alternatively, the second liquid 126 can be a non-polar liquid or an insulating liquid. The first liquid 124 can be substantially immiscible with, and has a different refractive index than, the second liquid 126, such that the interface 128 between the first liquid 124 and the second liquid 126 forms, thus making a lens. The first liquid 124 and the second liquid 126 can have substantially the same density, which can help to avoid changes in the shape of the interface 128 as a result of changing the physical orientation of the first liquid lens 100 (e.g., as a result of gravitational forces).

Again referring to FIG. 1, the liquid lens 100 further includes a first window 130 and a second window 132. The first window 130 can be part of the first outer layer 108. The second window 132 can be part of the second outer layer 110. For example, a portion of the first outer layer 108 covering the cavity 122 serves as the first window 130, and a portion of the second outer layer 110 covering the cavity 122 serves as the second window 132. In some embodiments, image light enters the first liquid lens 100 through the first window 130, is refracted at the interface 128 between the first liquid 124 and the second liquid 126, and exits the first liquid lens 100 through the second window 132.

The first outer layer 108 and/or the second outer layer 110 can comprise a sufficient transparency to enable passage of the image light. For example, the first outer layer 108 and/or the second outer layer 110 can comprise a polymeric, a glass, ceramic (e.g., a silicon wafer), or glass-ceramic material. Because image light can pass through the through hole 120 in the intermediate layer 112, the intermediate layer 112 need not be transparent to the image light. However, the intermediate layer 112 can be transparent to the image light. As noted earlier, the first outer layer 108, the second outer layer 110, and the intermediate layer 112 can all be transparent to the wavelength of a laser employed for liquid lens dicing operations. The intermediate layer 112 can comprise a metallic, polymeric, a glass, ceramic, or glass-ceramic material. In the illustrated embodiment, each of the first outer layer 108, the second outer layer 110, and the intermediate layer 112 comprise a glass material.

Referring again to the liquid lens 100 depicted in FIG. 1, the external surfaces 116, 118 of the first outer layer 108 and/or the second outer layer 110, respectively, can be, and in the illustrated embodiment, are substantially planar. Thus, although the first liquid lens 100 can function as a lens (e.g., by refracting image light passing through the interface 128), the external surfaces 116, 118 of the first liquid lens 100 can be flat, e.g., as distinct from the curved outer surfaces of a typical conventional, convex fixed lens. In other embodiments of the liquid lens 100, the external surfaces 116, 118 of the first outer layer 108 and/or the second outer layer 110, respectively, can be curved (e.g., concave or convex). Thus, the first liquid lens 100 comprises an integrated fixed lens.

As noted earlier, the liquid lens 100 further includes a first electrode 134 and a second electrode 136. The first electrode 134 is disposed between the first outer layer 108 and the intermediate layer 112 (first substrate 112). In embodiments, one or more intermediate layer(s) (e.g., intermediate layer(s) of varying compositions to match the refractive indices of the layers 108, 112 with the electrodes 134, 136; e.g., intermediate layer(s) of varying compositions to promote deposition of the electrodes 134, 136 over the layers 108 and/or 112, etc.) are present between the electrode 134 and either or both of the first outer layer 108 and the first substrate 112 (not shown). The second electrode 136 is disposed between the intermediate layer 112 and the second outer layer 110 and extends through the through hole 120 in the intermediate layer 112. The first electrode 134 and the second electrode 136 can be applied (such as by coating or sputtering) to the intermediate layer 112 as one contiguous electrode layer structure before the first outer layer 108 and the second outer layer 110 are attached to the intermediate layer 112. In other words, substantially all of the intermediate layer 112 can be coated with an electrode. The electrode layer or layer structure can then be segmented into the first electrode 134 and the second electrode 136. For example, the liquid lens 100 can include a scribe 138 in the electrode layer or structure to form or otherwise define the first electrode 134 and the second electrode 136 such that these electrodes are electrically isolated from one another.

In some embodiments, the first electrode 134 and the second electrode 136 are not transparent to the wavelength of a laser employed in laser dicing operations (e.g., at 1060 nm for an infrared CO₂ laser). Various configurations and materials that can be employed in the electrodes 134, 136 are shown in FIGS. 2A-2C, described in detail below. More generally, each of the first electrode 134 and the second electrode 136 can comprise one or more metal-containing materials within an electrically conductive structure 134a (see FIGS. 2A-2C and corresponding description below). The electrodes 134, 136 also can include an optical absorber structure 134b, which can include at least two metal oxide layers 234 with at least one metal layer 236 therebetween each pair of metal oxide layers 234 (see FIGS. 2A-2C and corresponding description below). For example, each of the electrically conductive structure 134a and the metal layer(s) 236 can include, but are not limited to, any of the following materials: Cr, Mo, Au, Ag, Ni, Ti, Cu, Al, a Ni/Au alloy, a Au/Si alloy, Zr, V, a Cu/Ni alloy, other alloys thereof or combinations thereof. In some implementations, the at least two metal oxide layers 234 can be conductive dielectric layers, which are characterized by a resistivity of less than about 1E-2 Ω·cm and a band gap of at least about 3.5 eV. In some implementations, each of the at least two metal oxide layers 234 is a transparent conductive oxide (TCO) such as indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), or combinations thereof.

Referring again to the liquid lens 100 depicted in FIG. 1, either of or both of the first electrode 134 and the second electrode 136 can comprise a single layer or a plurality of layers, some or all of which can be conductive. The first electrode 134 functions as a common electrode in electrical communication with the first liquid 124. The second electrode 136 functions as a driving electrode. The second electrode 136 is disposed on the through hole 120 as well as between the intermediate layer 112 and the second outer layer 110.

Once again referring to the liquid lens 100 depicted in FIG. 1, either or both of the first electrode 134 and the second electrode 136 can be characterized by some or all of the following optical properties. According to an implementation of the liquid lens 100, the electrodes 134, 136 can comprise a reflectivity minimum of about 3% or less at a visible wavelength within a range of 390 nm to 700 nm. In some embodiments, the electrodes 134, 136 can comprise a reflectivity minimum of about 3% or less, 2.5% or less, 2% or less, 1.5% or less, 1% or less, 0.5% or less, and all reflectivity minima between these values, as measured at a visible wavelength. As noted earlier, the electrodes 134, 136 of the disclosure with such low reflectivity levels in the visible spectrum help minimize stray optical reflections within the cone and aperture of the liquid lens 100 that could otherwise degrade optical performance of the lens. In some implementations of the liquid lens 100, the electrodes 134, 136 can comprise a reflectivity of about 25% or less at an ultraviolet (UV) wavelength within a range of 100 nm to 400 nm. In some embodiments, the electrodes 134, 136 can comprise a reflectivity of about 25% or less, 20% or less, 15% or less, 10% or less, 5% or less, 1% or less, and all reflectivity values between these limits, as measured at a UV wavelength. As also noted earlier, the electrodes 134, 136 of the disclosure with these low reflectivity levels in the UV spectrum are a factor in ensuring that laser processes can be employed effectively to bond the substrates 112 and 124 together, particularly with a UV laser. In particular, these low reflectivity levels in the electrodes 134, 136 reduce the laser input energy for bonding, which can also reduce temperature increases, particularly in proximity to the liquids 124, 126. According to some embodiments of the liquid lens 100, the electrodes 134, 136 can comprise an optical transmittance of at least about 70% at an infrared (IR) wavelength within a range of 800 nm to 1700 nm. In embodiments, the electrodes 134, 136 can comprise an optical transmittance of at least about 70%, 75%, 80%, 85%, 90%, 95%, and all optical transmittance levels between these values, as measured at an IR wavelength. As noted earlier, the liquid lens 100 of the disclosure with electrodes 134 having such optical transmittance levels in the IR spectrum can enable a bond 146, as defined at least in part by the electrode 134, to be sufficiently transparent to the wavelength range of lasers that can be employed in subsequent dicing operations (e.g., from 800 nm to 1.7 μm).

Once again referring to the liquid lens 100 depicted in FIG. 1, either or both of the first electrode 134 and the second electrode 136 can be characterized by some or all of the following electrical properties. According to an implementation of the liquid lens 100, the electrodes 134, 136 can comprise a sheet resistance from about 5 Ω/sq to about 0.5 Ω/sq. In some implementations of the liquid lens 100, the electrodes 134, 136 can comprise a sheet resistance of about 5 Ω/sq, 4.5 Ω/sq, 4.0 Ω/sq, 3.5 Ω/sq, 3.0 Ω/sq, 2.5 Ω/sq, 2.0 Ω/sq, 1.5 Ω/sq, 1.0 Ω/sq, 0.5 Ω/sq, and all sheet resistance values between these sheet resistance levels. With these sheet resistance levels, the electrodes 134, 136 have current carrying capability to allow for the induced voltage variations associated with proper operation of the device employing the liquid lens 100. These sheet resistance levels in the electrodes 134, 136 are also at a level that heater electrodes (e.g., resistance-heater electrodes) patterned from them can be configured to heat the device employing the liquid lens 100 to improve operation under low (e.g., sub-zero) temperature evolutions. According to some embodiments of the liquid lens 100 in which the electrodes 134, 136 comprise an absorber structure 134b (see FIGS. 2A-2C and corresponding description below), each of the metal oxide layers 234 (e.g., as conductive dielectric layers) comprises a resistivity of less than 1E-2 Ω·cm. In some aspects, each of the metal oxide layers 234 comprises a resistivity of less than 1E-2 Ω·cm, 9E-3 Ω·cm, 8E-3 Ω·cm, 7E-3 Ω·cm, 6E-3 Ω·cm, 5E-3 Ω·cm, 4E-3 Ω·cm, 3E-3 Ω·cm, 2E-3 Ω·cm, 1E-3 Ω·cm, 9E-4 Ω·cm, 8E-4 Ω·cm, 7E-4 Ω·cm, 6E-4 Ω·cm, 5E-4 Ω·cm, 4E-4 Ω·cm, 3E-4 Ω·cm, 2E-4 Ω·cm, 1E-4 Ω·cm, and all resistivity values between these resistivity levels. As noted earlier, electrodes 134, 136 that include metal oxide layers 234 with these resistivity levels can enable improved interconnections that do not require additional patterning or etching of the electrodes 234. In some embodiments, the electrodes 134, 136 that comprise two or more conductive dielectric layers are configured such that these dielectric layers have a band gap of at least 3.5 eV. According to an implementation, the electrodes 134, 136 that comprise two or more conductive dielectric layers are configured such that these dielectric layers have a band gap of at least 3.5 eV, 4.0 eV, 4.5 eV, 5.0 eV, and even larger band gaps. Without being bound by theory, electrodes 134, 136 comprising two or more layers with band gap levels above 3.5 eV possess one more of the foregoing optical properties (e.g., reflectivity levels in the visible and UV spectra; transmittance in the IR spectra) while also possessing some or all of the foregoing electrical properties.

The second electrode 136 is insulated from the first liquid 124 and the second liquid 126, via an insulating layer 140. The insulating layer 140 can comprise an insulating coating applied to the intermediate layer 112 before attaching the first outer layer 108 and/or the second outer layer 110 to the intermediate layer 112. The insulating layer 140 can comprise an insulating coating applied to the second electrode 136 and the second window 132 after attaching the second outer layer 110 to the intermediate layer 112 and before attaching the first outer layer 108 to the intermediate layer 112. Thus, the insulating layer 140 covers at least a portion of the second electrode 136 within the cavity 122 and the second window 132. The insulating layer 140 can be sufficiently transparent to enable passage of image light through the second window 132 as described herein. The insulating layer 140 can cover at least a portion of the second electrode 136 (acting as the driving electrode) (e.g., the portion of the second electrode 136 disposed within the cavity 122) to insulate the first liquid 124 and the second liquid 126 from the second electrode 136. Additionally, or alternatively, at least a portion of the first electrode 134 (acting as the common electrode) disposed within the cavity 122 is uncovered by the insulating layer 140. Thus, the first electrode 134 can be in electrical communication with the first liquid 124 as described herein.

The liquid lens 100 depicted in FIG. 1 can include one or more apertures through the first outer layer 108 (not shown). The apertures comprise portions of the liquid lens 100 at which the first electrode 134 is exposed through the first outer layer 108, such as via removal of a portion of the first outer layer 108 or otherwise. Thus, the apertures are configured to enable electrical connection to the first electrode 134, and the regions of the first electrode 134 exposed at the apertures can serve as contacts to enable electrical connection of the liquid lens 100 to a controller, a driver, or another component of a lens or camera system (not shown). In other words, the apertures provide an electrical contact point between the liquid lens 100 and another electrical device. In embodiments, the interconnections between the liquid lens 100, and specifically the first electrode 134, to another component of the lens can be made without any etching or patterning of electrode 134 prior to the interconnection step.

Likewise, the liquid lens 100 depicted in FIG. 1 can also comprise one or more apertures through the second outer layer 110, according to some embodiments (not shown). These apertures comprise portions of the liquid lens 100 at which the second electrode 136 is exposed through the second outer layer 110, such as via removal of a portion of the second outer layer 110 or otherwise. Thus, the apertures are configured to enable electrical connection to the second electrode 136, and the regions of the second electrode 136 exposed at the apertures can serve as contacts to enable electrical connection of the liquid lens 100 to a controller, a driver, or another component of a lens or camera system (not shown). In embodiments, the interconnections between the liquid lens 100, and specifically the second electrode 136, to another component of the lens can be made without any etching or patterning of electrode 136 prior to the interconnection step.

Referring again to the liquid lens 100 depicted in FIG. 1, the prior-described apertures (not shown) provide an electrical contact point between the liquid lens 100 and another electrical device. Different voltages can be supplied to the first electrode 134 and the second electrode 136 via the apertures (and the attendant interconnections) to change the shape of the interface 128, a process referred to as electrowetting. For example, applying a voltage to increase or decrease the wettability of the surface of the cavity 122 with respect to the first liquid 124 can change the shape of the interface 128. Changing the shape of the interface 128 can change the focal length or focus of the liquid lens 100. For example, such a change of focal length can enable the liquid lens 100 to perform an autofocus function. Additionally, or alternatively, adjusting the interface 128 can tilt the interface 128 relative to the optical axis 114 of the liquid lens 100. For example, such tilting can enable the liquid lens 100 to perform an optical image stabilization (OIS) function. Adjusting the interface 128 can be achieved without physical movement of the liquid lens 100 relative to an image sensor, a fixed lens or lens stack, a housing, or other components of a camera module in which the liquid lens 100 can be incorporated.

According to an embodiment of the liquid lens 100 depicted in FIG. 1, the liquid lens includes a bond 146 defined at least in part by the electrode 134, wherein the bond 146 hermetically seals the first outer layer 108 to the intermediate layer 112. In embodiments, the bond 146 can be characterized by an optical transmittance of at least 70% at an infrared wavelength within a range of 800 nm to 1.7 μm, e.g., such that the bond 146 is transparent to the wavelength of a laser employed in subsequent dicing operations (e.g., 1060 nm for an infrared CO₂ laser). In some embodiments, the structure and composition of the electrode 134 is configured such that the bond 146 within the liquid lens 100 results in (a) an electrode 134 that is diffused, partially diffused melted, or otherwise incorporated into the first outer layer 108 and the intermediate layer 112 and (b) a bond 146 is transparent to the wavelength range of lasers that can be employed in subsequent dicing operations (e.g., from 800 nm to 1.7 μm). In other words, the first outer layer 108 is bonded with the intermediate layer 112 at the bond 146, and the resulting bond formed enables subsequent dicing operations. In some embodiments, the bond 146 includes a portion of the electrode 134 diffused into both the first outer layer 108 and the intermediate layer 112. In embodiments, the second outer layer 110 is bonded with the intermediate layer 112 at a bond that can be configured as described herein with reference to the bond 146. For example, the bonds between the first outer layer 108 and the intermediate layer 112 and between the second outer layer 110 and the intermediate layer 112 can be aligned with each other such that a transparent dicing pathway extends entirely or substantially entirely through the thickness of the liquid lens 100. The transparent dicing pathway can be transparent to the wavelength range of lasers that can be employed in subsequent dicing operations as described herein.

Referring now to FIGS. 2A-2C, a liquid lens article 100a is depicted according to various embodiments. In embodiments, the liquid lens 100 depicted in FIG. 1 includes or otherwise incorporates a liquid lens article 100a (e.g., as a subassembly or precursor element), and like-numbered elements in FIGS. 1-2C have the same or a substantially similar structure and function. The liquid lens article 100a depicted in FIGS. 2A-2C includes a first substrate 112 with a primary surface 112a. The liquid lens article 100a also includes an electrode 134 disposed on the primary surface 112a of the first substrate 112. The electrode 134 of the liquid lens article 100a includes an electrically conductive structure 134a disposed on the primary surface 112a of the first substrate 112 and an optical absorber structure 134b (see FIGS. 2A-2C) disposed on the electrically conductive structure 134a. Further, the absorber structure 134b comprises at least two metal oxide layers 234 and at least one metal layer 236, each metal layer 236 between two of the metal oxide layers 234. The properties and various compositions associated with each of the layers and structures of the electrode 134 are described earlier in connection with the liquid lens 100 depicted in FIG. 1.

Referring again to the liquid lens article 100a depicted in FIGS. 2A-2C, the electrically conductive structure 134a can be fabricated from or otherwise include a metal or metal alloy that includes Cr, Mo, Au, Ag, Ni, Ti, Cu, Al, a Ni/Au alloy, a Au/Si alloy, Zr, V, a Cu/Ni alloy, or combinations thereof. The electrically conductive structure 134a can be fabricated from a single layer, multiple layers, a composite having a matrix or second phases including the above metal or metal alloy materials. An exemplary example is shown in FIG. 2A in which an embodiment of the liquid lens article 100a is configured with an electrically conductive structure 134a with one metal layer disposed between the first substrate 112 and the optical absorber structure 134b. As shown in FIG. 2B, embodiments of the liquid lens article 100a can be configured with an electrically conductive structure 134a with a pair of metal layers disposed between the first substrate 112 and the optical absorber structure 134b. Referring to FIG. 2C, as another example, embodiments of the liquid lens article 100a can be configured with an electrically conductive structure 134a fabricated from three metal layers disposed between the first substrate 112 and the optical absorber structure 134b.

Referring again to the liquid lens article 100a depicted in FIGS. 2A-2C, embodiments of the electrically conductive structure 134a are fabricated from one or more layers or structures with a total thickness from about 5 nm to about 300 nm, from about 10 nm to about 250 nm, or from about 30 nm to about 200 nm. In some embodiments, the thickness of the one or more layers of the electrically conductive structure 134a is about 5 nm, 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, and all thickness values between these thicknesses.

Referring to the liquid lens article 100a depicted in FIGS. 2A-2C, the optical absorber structure 134b comprises at least two metal oxide layers 234 and at least one metal layer 236, each metal layer 236 between two of the metal oxide layers 234. In some embodiments, each of the at least one metal layer 236 of the optical absorber structure 134b can be fabricated from a metal or metal alloy that includes Cr, Mo, Au, Ag, Ni, Ti, Cu, Al, a Ni/Au alloy, a Au/Si alloy, Zr, V, a Cu/Ni alloy, or combinations thereof. According to some embodiments, each of the at least two metal oxide layers 234 of the absorber structure 134b can be fabricated from a transparent conductive oxide (TCO) including but not limited to indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), or combinations thereof. In some embodiments, the optical absorber structure 134b of the liquid lens article 100a can comprise more than two metal oxide layers 234 and more than one metal layer 236. For example, the optical absorber structure 134b can include three metal oxide layers 234 and two metal layers 236, such that each metal layer 236 is disposed between two of the metal oxide layers 234 (not shown). That is, in this exemplary configuration, the metal oxide layers 234 and the metal layers 236 are alternating within the optical absorber structure 134b.

Referring again to the liquid lens article 100a depicted in FIGS. 2A-2C, embodiments of the optical absorber structure 134b are fabricated from multiple layers and/or structures with a total thickness from about 0.1 nm to about 200 nm, from about 0.5 nm to about 150 nm, or from about 1 nm to about 150 nm. In some embodiments, the total thickness of the optical absorber structure 134b is about 0.1 nm, 0.5 nm, 1 nm, 5 nm, 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, and all thickness values between these thicknesses. In some implementations of the optical absorber structure 134b, the thickness of each of the metal layers 236 is from about 0.5 nm to 50 nm, from about 1 nm to about 50 nm, from about 1 nm to about 25 nm, or from about 2 nm to about 20 nm. In some embodiments, the thickness of each of the metal layers 236 is about 0.5 nm, 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 25 nm, 30 nm, 35 nm, 40 nm, 45 nm, 50 nm, and all thickness values between these values. In other implementations of the optical absorber structure 134b, the thickness of each of the metal oxide layers 234 is from about 5 nm to about 100 nm, from about 10 nm to about 75 nm, or from about 20 nm to about 60 nm. In some embodiments, the thickness of each of the metal oxide layers 234 is from about 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, and all thickness values between these levels.

Referring now to FIG. 2, a liquid lens article 100a is depicted in which the article further includes a second substrate 108 disposed on the optical absorber structure 134b (not shown) of the electrode 134. The liquid lens article 100a, as depicted in FIG. 2, further includes a bond 146 that is defined at least in part by the electrode 134. The bond 146 hermetically seals the first substrate 112 and the second substrate 108. As noted earlier in connection with the liquid lens 100 (see FIG. 1 and corresponding description), the bond 146 can be formed with a UV laser (e.g., a CO₂ laser at 1060 nm). Advantageously, as also noted earlier, the electrode 134, which is part of the bond 146, can be characterized by a reflectivity of about 25% or less at a UV wavelength, which facilitates the formation of the bond 146 with a UV laser. Further, according to some implementations, the bond 146, as formed from the electrode 134 and substrates 108, 112, can be characterized by an optical transmittance of at least 70% at an IR wavelength. Accordingly, the bonds 146 with such optical transmittance are advantageously configured to facilitate subsequent operations and processes to dice a liquid lens 100 (see FIG. 1) from an array of liquid lenses 100 (not shown) with an IR laser.

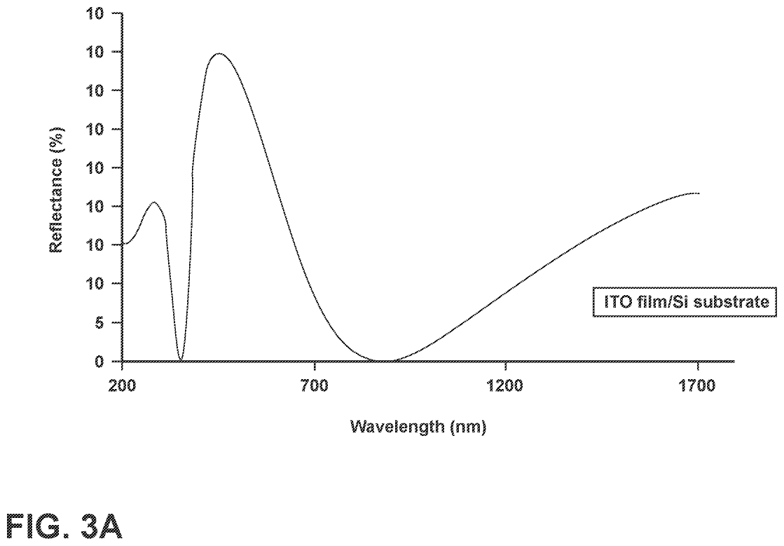

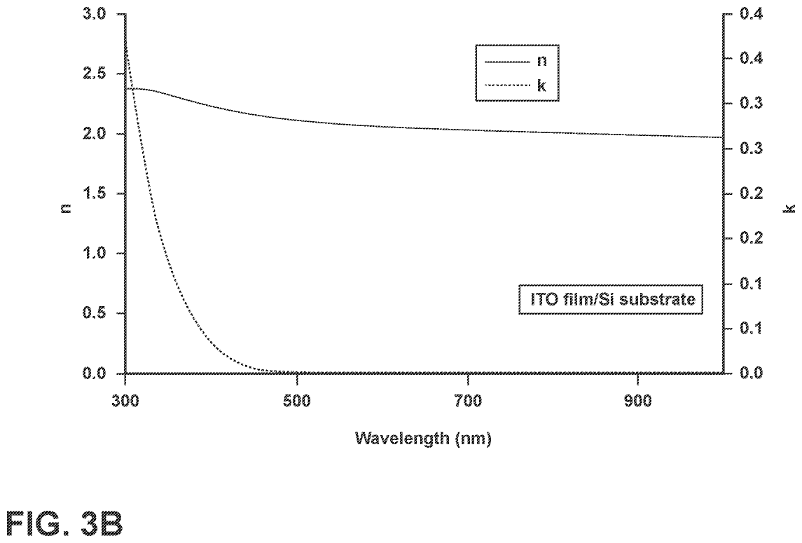

Referring now to FIGS. 3A and 3B, plots of reflectance and refractive indices as a function of wavelength of an indium tin oxide (ITO) film sputtered on a silicon wafer are provided, respectively. In particular, the ITO film has a thickness of about 113 nm, as deposited on a 150 mm diameter silicon wafer from a 95/5 target by pulse DC sputtering on an Applied Materials Centura physical vapor deposition (PVD) apparatus at 200° C. Further, the sputtering was conducted in an environment of 40 sccm argon gas and 1.5 sccm O₂ gas at a pressure of 2.7 mTorr, with 750 W of DC power pulsed at 50 kHz with a 8016 ns cycle time. FIG. 3A shows the reflectance spectra for this film. FIG. 3B depicts the refractive index as a function of wavelength for this sample from spectroscopic ellipsometry using a Tauc-Lorentz model. As is evident from the data in FIGS. 3A and 3B, this sample does not exhibit strong absorption in the near IR spectrum, as consistent with a low free carrier density. Further, the resistivity of this sample was measured at 3.24E-3 Ω·cm. Without being bound by theory, it is believed that these optical measurements on this ITO film on a silicon wafer are indicative of results that would be expected for various transparent conductive oxide (TCO) materials, such as indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), or combinations thereof. Further, as TCO films exhibit relatively low optical absorption in the visible spectrum, the electrodes 134 of the disclosure can be configured with two or more of these TCO layers with a metal layer between each pair of them to form one or more dielectric cavities that null or otherwise mitigate reflections in the visible spectrum from the underlying electrically conductive layer 134a of the electrode 134.

### EXAMPLES

The following examples describe various features and advantages provided by the disclosure, and are in no way intended to limit the disclosure and appended claims.

### Example 1

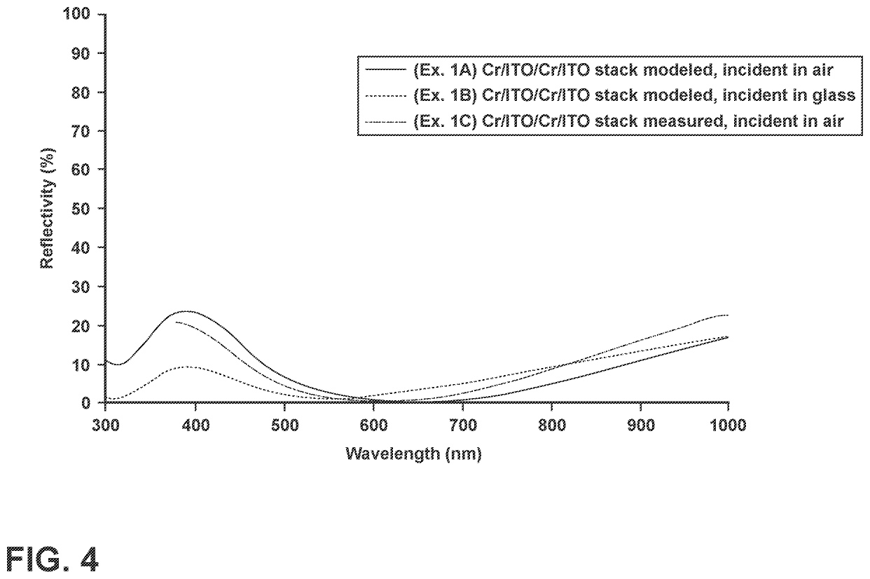

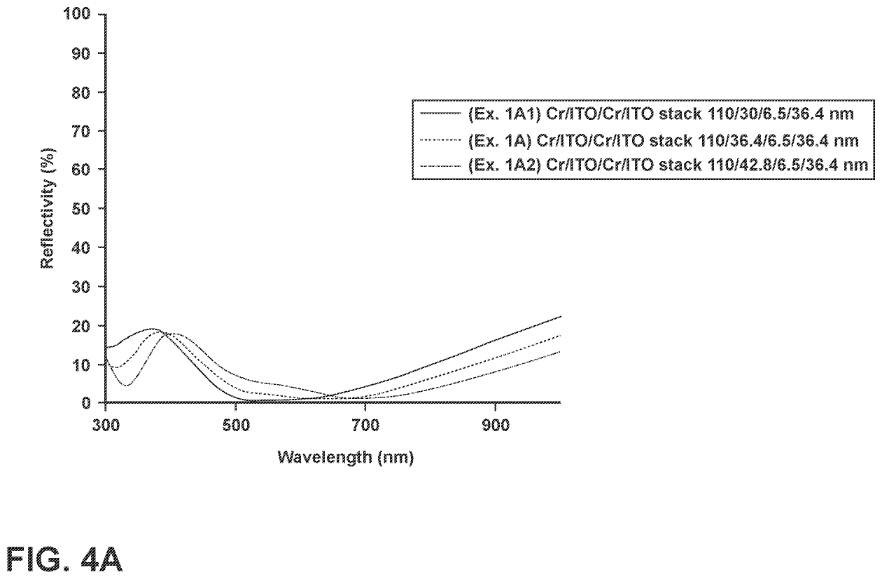

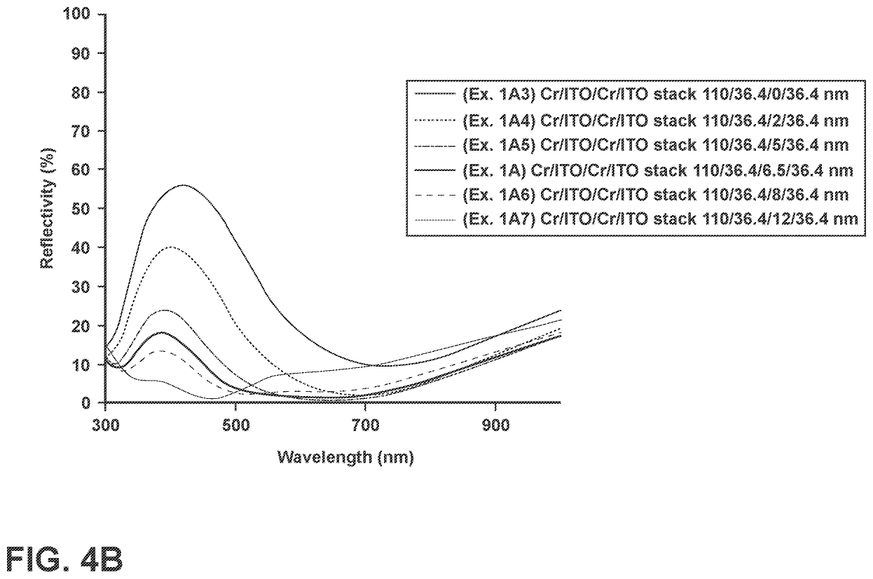

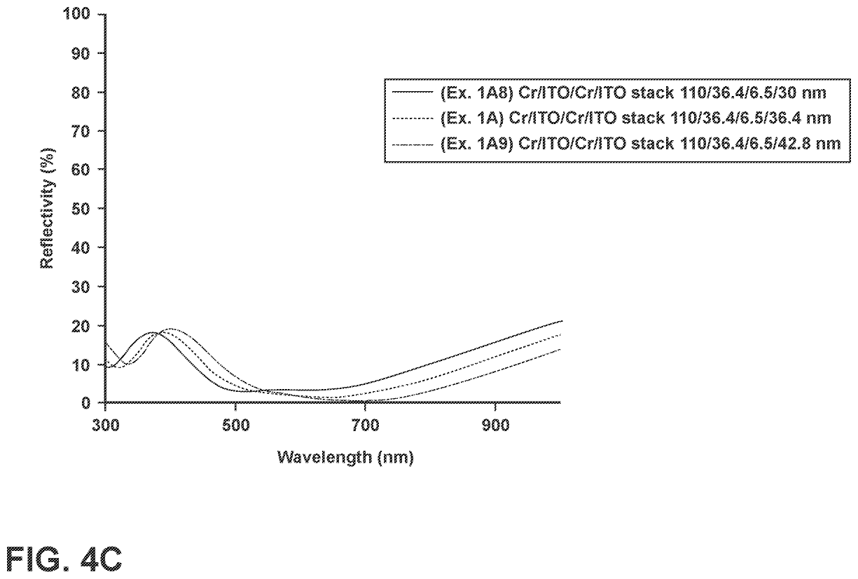

In this example, a liquid lens article consistent with the liquid lens articles 100a of the disclosure was prepared (see FIG. 2A). As noted below in Table 1, the substrate has a glass composition and the electrode includes the following layers successively disposed over the substrate: a Cr film having a thickness of 110 nm (e.g., an electrically conductive structure 134a); an ITO film having a thickness of 36.4 nm (e.g., a metal oxide layer 234); a Cr film having a thickness of 6.5 nm (e.g., a metal layer 236); and an ITO film having a thickness of 36.4 nm (e.g., a metal oxide layer 234). Referring to FIG. 4, the simulated reflectance of a model of the liquid lens article of this example is provided, as incident in air (Ex. 1A) and glass (Ex. 1B) (i.e., to simulate the presence of an additional substrate 108 as within a liquid lens 100, as shown in FIG. 1), and as measured on an actual sample from this example, as incident in air (Ex. 1C). From the reflectance vs wavelength curve of the bonded design in this example with an additional substrate shown in FIG. 4 (Ex. 1B), is it evident that the visible reflectivity is less than about 1% with near neutral color. FIG. 4 also shows that the 355 nm reflectivity of the bonded sample (Ex. 1B) in the UV range is also ˜4%. It is also evident that the other samples of this example (Ex. 1A and 1C), as incident in air, exhibit similar reflectivity levels across the UV and visible spectra. Finally, a sheet resistivity of 2.3 Ω/sq was measured for each of the actual multi-layer electrode sample and the individual 110 nm Cr layer of this example.

TABLE 1
Cr/ITO/Cr/ITO electrode (Ex. 1A)

| Material | Thickness | |
|---|---|---|
| glass substrate | | |
| Cr film | 110 | nm |
| ITO film | 36.4 | nm |
| Cr film | 6.5 | nm |
| ITO film | 36.4 | nm |

| | |
|---|---|
| air | N/A |

Referring now to FIGS. 4A-4C, reflectance spectra of the Cr/ITO/Cr/ITO electrode depicted in FIG. 4 is provided for configurations with varying thicknesses of the layers of the electrode. More particularly, the spectra of FIGS. 4A-4C constitute a reflectance-based sensitivity analysis of the electrode design of this example, as detailed earlier and in Table 1. In FIG. 4A, the thickness of the first ITO layer over the thick Cr film is varied with thicknesses of 30 nm (Ex. 1A1) and 42.8 nm (Ex. 1A2), as compared to the Ex. 1A design of Table 1 with a first ITO film thickness of 36.4 nm. With regard to FIG. 4B, the thickness of the Cr film between the ITO films is varied with thicknesses of 0 nm, 2 nm, 5 nm, 8 nm and 12 nm (Exs. 1A3, 1A4, 1A5, 1A6 and 1A7, respectively), as compared to the Ex. 1A design of Table 1 with a Cr film thickness of 6.5 nm. With regard to FIG. 4C, the thickness of the second ITO layer over the thin Cr film is varied with thickness of 30 nm (Ex. 1A8) and 42.8 nm (Ex. 1A9), as compared to the Ex. 1A design of Table 1 with a second ITO film thickness of 36.4 nm. As is evident from FIGS. 4A and 4C, thinning the first and/or second ITO films tends to shift the reflectance minima to shorter wavelengths, while thickening these films tends to shift the reflectance minima toward longer wavelengths. As is evident from FIG. 4B, however, reflectance is most sensitive to the thickness of the Cr film between the ITO films. Reducing the thickness of the Cr film to 0 nm essentially results in a thick, single layer dielectric of ITO material which shifts the reflectance minima to longer wavelengths. On the other hand, particularly thick Cr films in this electrode design, e.g., greater than 5 nm (i.e., Exs. 1A, 1A6, 1A7), tend to reduce the reflectivity minima and shift them toward shorter wavelengths.

### Example 2

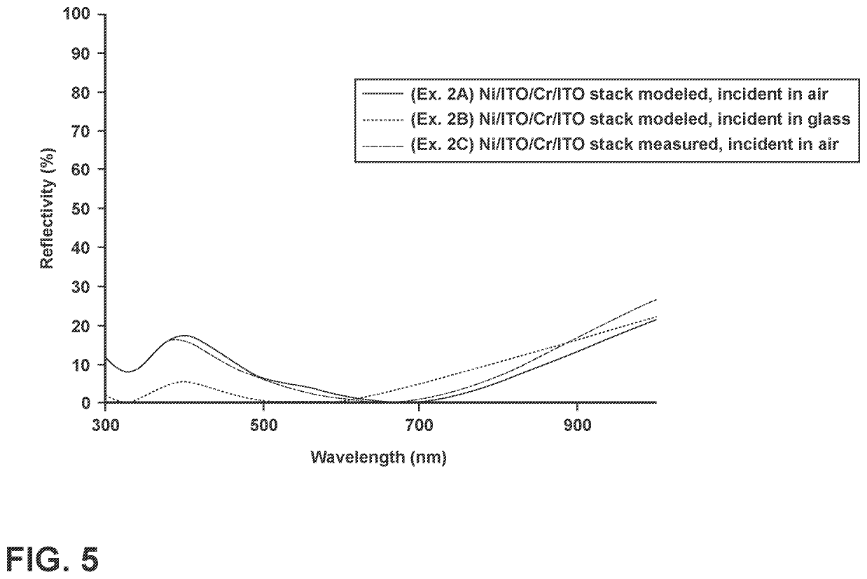

In this example, a liquid lens article consistent with the liquid lens articles 100a of the disclosure was prepared (see FIG. 2A). As noted below in Table 2, the substrate has a glass composition and the electrode includes the following layers successively disposed over the substrate: a Ni film having a thickness of 60 nm (e.g., an electrically conductive structure 134a); an ITO film having a thickness of 36.4 nm (e.g., a metal oxide layer 234); a Cr film having a thickness of 6.5 nm (e.g., a metal layer 236); and an ITO film having a thickness of 36.4 nm (e.g., a metal oxide layer 234). Referring to FIG. 5, the simulated reflectance of a model of the liquid lens article of this example is provided, as incident in air (Ex. 2A) and glass (Ex. 2B) (i.e., to simulate the presence of an additional substrate 108 as within a liquid lens 100, as shown in FIG. 1), and as measured on an actual sample from this example, as incident in air (Ex. 2C). From the reflectance vs wavelength curve of the bonded design in this example with an additional substrate shown in FIG. 5 (Ex. 2B), it is evident that the visible reflectivity is less than about 0.5% with near neutral color. FIG. 5 also shows that the 355 nm reflectivity of the bonded sample (Ex. 2B) in the UV range is also ˜2.5%. It is also evident that the other samples of this example (Ex. 2A and 2C), as incident in air, exhibit similar reflectivity levels across the UV and visible spectra. Finally, a sheet resistivity of 1.4 Ω/sq was measured for each of the actual multi-layer electrode sample and the individual 60 nm Ni film of this example.

TABLE 2
Ni/ITO/Cr/ITO electrode (Ex. 2A)

| Material | Thickness | |
|---|---|---|
| glass substrate | | |
| Ni film | 60 | nm |
| ITO film | 36.4 | nm |
| Cr film | 6.5 | nm |
| ITO film | 36.4 | nm |

| | |
|---|---|
| air | N/A |

### Example 3

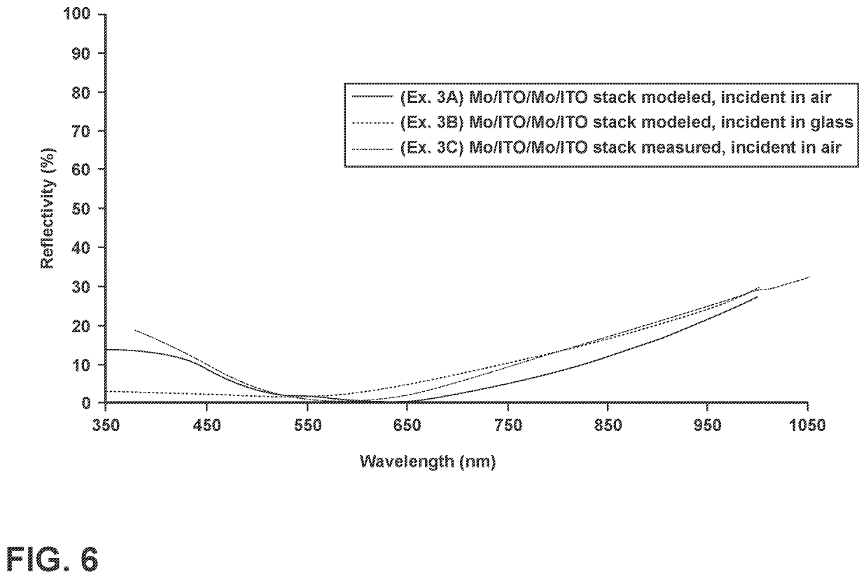

In this example, a liquid lens article consistent with the liquid lens articles 100a of the disclosure was prepared (see FIG. 2A). As noted below in Table 3, the substrate has a glass composition and the electrode includes the following layers successively disposed over the substrate: a Mo film having a thickness of 50 nm (e.g., an electrically conductive structure 134a); an ITO film having a thickness of 25 nm (e.g., a metal oxide layer 234); a Mo film having a thickness of 4 nm (e.g., a metal layer 236); and an ITO film having a thickness of 40 nm (e.g., a metal oxide layer 234). Referring to FIG. 6, the simulated reflectance of a model of the liquid lens article of this example is provided, as incident in air (Ex. 3A) and glass (Ex. 3B) (i.e., to simulate the presence of an additional substrate 108 as within a liquid lens 100, as shown in FIG. 1), and as measured on an actual sample from this example, as incident in air (Ex. 3C). From the reflectance vs wavelength curve of the bonded design in this example with an additional substrate shown in FIG. 6 (Ex. 3B), is it evident that the visible reflectivity is less than about 2% with near neutral color. FIG. 6 also shows that the 355 nm reflectivity of the bonded sample (Ex. 3B) in the UV range is also ˜3%. It is also evident that the other samples of this example (Ex. 3A and 3C), as incident in air, exhibit similar reflectivity levels across the UV and visible spectra. Finally, a sheet resistivity of 2.0 Ω/sq was measured for each of the actual multi-layer electrode sample and the individual 50 nm Mo film of this example.

TABLE 3
Mo/ITO/Mo/ITO electrode (Ex. 3A)

| Material | Thickness | |
|---|---|---|
| glass substrate | | |
| Mo film | 50 | nm |
| ITO film | 25 | nm |
| Mo film | 4 | nm |
| ITO film | 40 | nm |

| | |
|---|---|
| air | N/A |

### Example 4

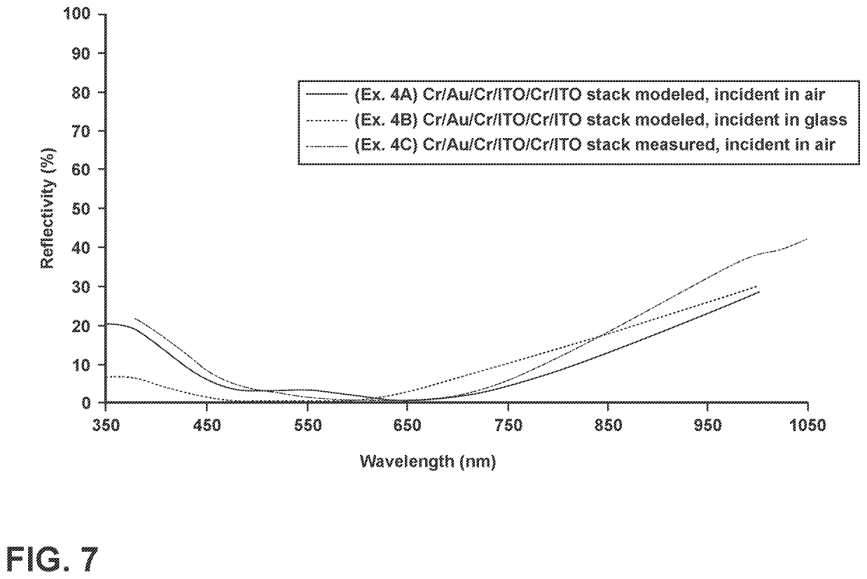

In this example, a liquid lens article consistent with the liquid lens articles 100a of the disclosure was prepared (see FIG. 2C). As noted below in Table 4, the substrate has a glass composition and the electrode includes the following layers successively disposed over the substrate: a Cr film having a thickness of 10 nm, a Au film having a thickness of 60 nm and a Cr film having a thickness of 10 nm (e.g., collectively, an electrically conductive structure 134a as shown in FIG. 2C); an ITO film having a thickness of 30 nm (e.g., a metal oxide layer 234); a Cr film having a thickness of 5 nm (e.g., a metal layer 236); and an ITO film having a thickness of 30 nm (e.g., a metal oxide layer 234). Referring to FIG. 7, the simulated reflectance of a model of the liquid lens article of this example is provided, as incident in air (Ex. 4A) and glass (Ex. 4B), and as measured on an actual sample from this example, as incident in air (Ex. 4C). From the reflectance vs wavelength curve of the bonded design in this example with an additional substrate shown in FIG. 7 (Ex. 4B), is it evident that the visible reflectivity is less than about 1% with near neutral color. FIG. 7 also shows that the 355 nm reflectivity of the bonded sample (Ex. 4B) in the UV range is also ˜7%. It is also evident that the other samples of this example (Ex. 4A and 4C), as incident in air, exhibit similar reflectivity levels across the UV and visible spectra. Finally, a sheet resistivity of 1.1 Ω/sq was measured for each of the actual multi-layer electrode sample and the individual 60 nm Au film of this example.

TABLE 4
Cr/Au/Cr/ITO/Cr/ITO electrode (Ex. 4A)

| Material | Thickness | |
|---|---|---|
| glass substrate | | |
| Cr film | 10 | nm |
| Au film | 60 | nm |
| Cr film | 10 | nm |
| ITO film | 30 | nm |
| Cr film | 5 | nm |
| ITO film | 30 | nm |

| | |
|---|---|
| air | N/A |

### Example 5

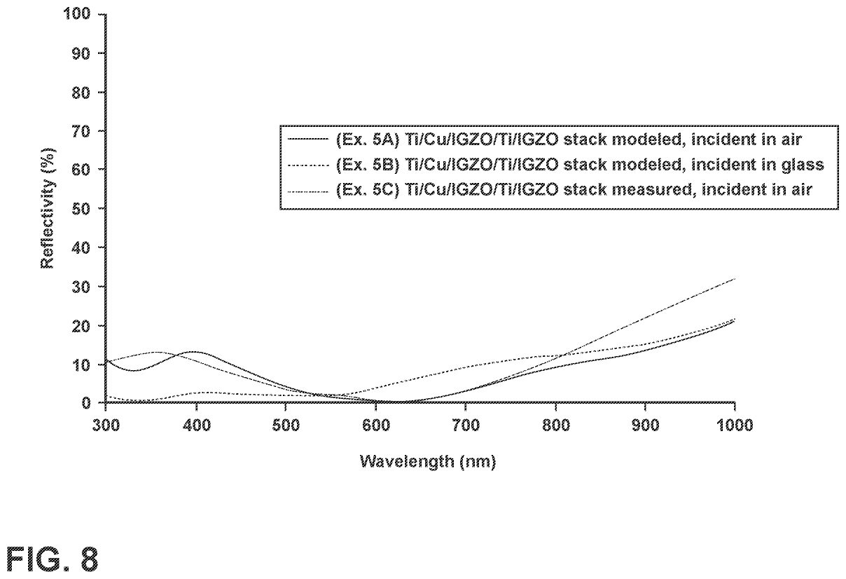

In this example, a liquid lens article consistent with the liquid lens articles 100a of the disclosure was prepared (see FIG. 2B). As noted below in Table 5, the substrate has a glass composition and the electrode includes the following layers successively disposed over the substrate: a Ti film having a thickness of 5 nm and a Cu film having a thickness of 40 nm (e.g., collectively, an electrically conductive structure 134a as shown in FIG. 2B); an indium gallium zinc oxide (IGZO) film having a thickness of 35 nm (e.g., a metal oxide layer 234); a Ti film having a thickness of 12 nm (e.g., a metal layer 236); and an IGZO film having a thickness of 35 nm (e.g., a metal oxide layer 234). Referring to FIG. 8, the simulated reflectance of a model of the liquid lens article of this example is provided, as incident in air (Ex. 5A) and glass (Ex. 5B), and as measured on an actual sample from this example, as incident in air (Ex. 5C). From the reflectance vs wavelength curve of the bonded design in this example with an additional substrate shown in FIG. 8 (Ex. 5B), is it evident that the visible reflectivity is less than about 3% with near neutral color. FIG. 8 also shows that the 355 nm reflectivity of the bonded sample (Ex. 5B) in the UV range is also ˜2%. It is also evident that the other samples of this example (Ex. 5A and 5C), as incident in air, exhibit similar reflectivity levels across the UV and visible spectra. Finally, a sheet resistivity of 1.3 Ω/sq was measured for each of the actual multi-layer electrode sample and the individual 40 nm Cu film of this example.

TABLE 5
Ti/Cu/IGZO/Ti/IGZO electrode (Ex. 5A)

| Material | Thickness | |
|---|---|---|
| glass substrate | | |
| Ti film | 5 | nm |
| Cu film | 40 | nm |
| IGZO film | 35 | nm |
| Ti film | 12 | nm |
| IGZO film | 35 | nm |

| | |
|---|---|
| air | N/A |

### Example 6

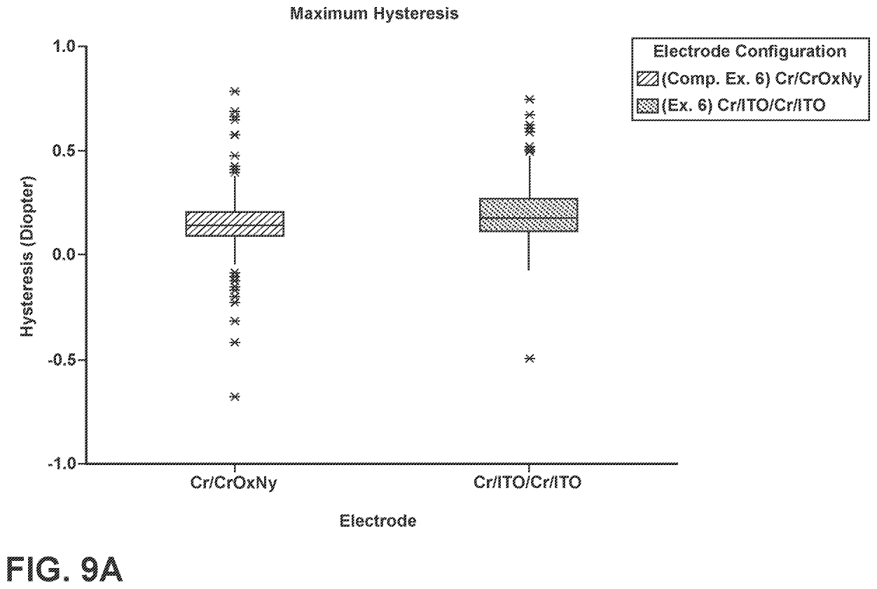

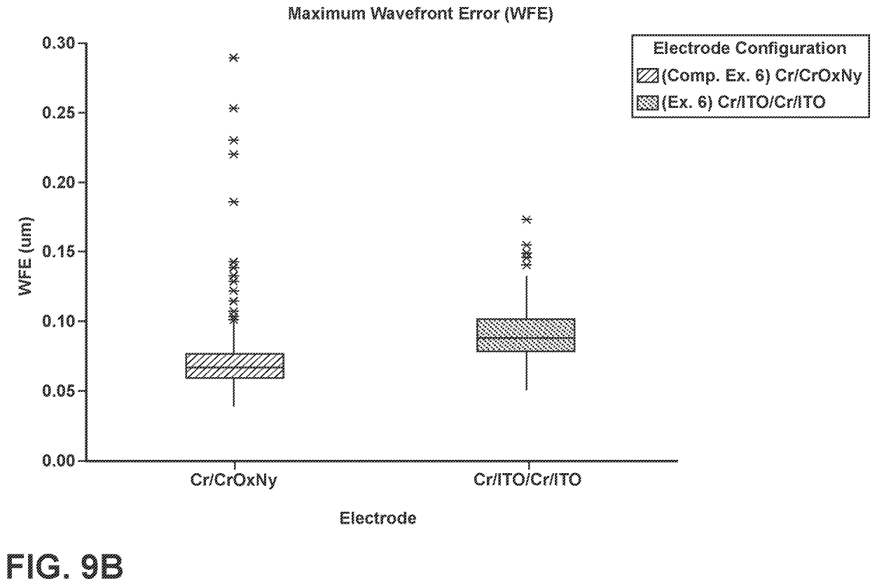

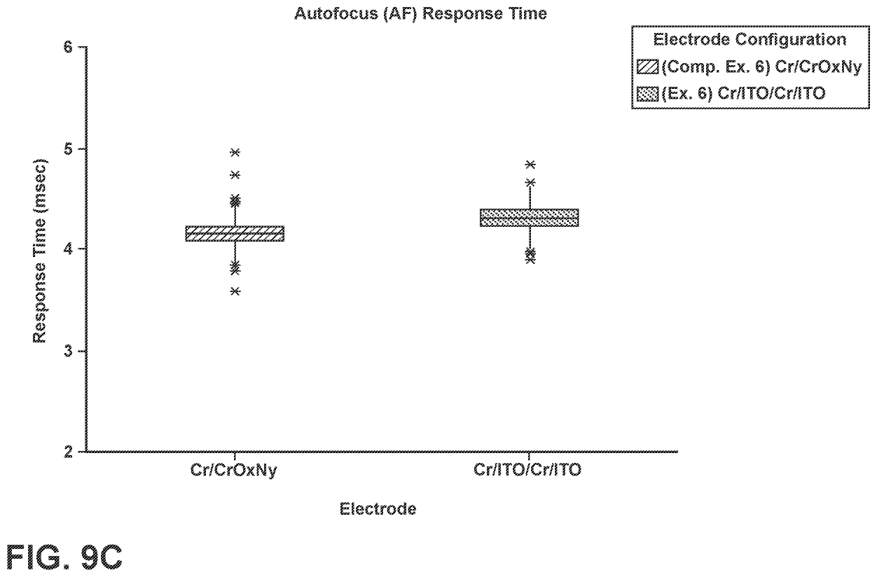

Referring now to FIGS. 9A-9C, box plots of measured parameters of liquid lenses fabricated with a comparative Cr/CrOₓN_{y} electrode configuration (Comp. Ex. 6) and a Cr/ITO/Cr/ITO electrode (e.g., an electrode comparable to the Ex. 1C shown in FIG. 4) configuration (Ex. 6). While electrodes with the Cr/CrOₓN_{y} configurations can exhibit optical properties that are comparable to those of the electrodes of the disclosure in some instances (e.g., low UV and visible spectra reflectivity), the CrOₓN_{y} portion is electrically insulating. As such, these comparative electrodes must be etched or otherwise patterned prior to interconnection. Not only is the etching and patterning costly, the processes are often difficult to control as the etchants employed to etch the CrOₓN_{y} portion tend to etch the underlying electrical conductive metal layer comprising Cr, Cu, Ni, Al and other metals.

Samples of each of these liquid lens devices, as fabricated with these electrode configurations (Comp. Ex. 6 and Ex. 6), were placed on an optical test bench with a Shack-Hartmann wavefront sensor optical instrument. A collimated light source was then used to generate incident light that passed through each of the liquid lens devices to reach the wavefront sensor. Data from the wavefront sensor was then employed to calculate power, tilt and wavefront error (WFE). More particularly, FIG. 9A is a box plot of maximum hysteresis for these samples, i.e., the maximum hysteresis in the power range of the liquid lens device reported in units of diopters. FIG. 9B is a box plot of WFE in the power range of the liquid lens device reported in units of microns (μm). FIG. 9C is a box plot of autofocus (AF) response time, as reported in milliseconds (msec). The AF response time is the time it takes the liquid lens device to reach 90% of the desired final diopter from 10% of the starting diopter point. The corresponding voltage for the starting diopter is applied and a sufficient time is allowed for the lens to settle before the test is initiated. Upon initiation of the test, the voltage for the final diopter point is applied and the resulting diopter is measured in increments of 2 msec. From this data set, the 10% to 90% response time can be interpolated to generate the AF time. Ultimately, as is evident from the box plots in FIGS. 9A-9C, the liquid lenses with the Cr/ITO/Cr/ITO electrode configuration according to this disclosure (Ex. 6) exhibited comparable liquid lens device performance as liquid lens devices with the comparative Cr/CrOₓN_{y} electrode configuration (Comp. Ex. 6) in terms of maximum hysteresis, maximum wavefront error and autofocus response time.

According to a first embodiment of the disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises at least two metal oxide layers and at least one metal layer, each metal layer between two of the metal oxide layers. In addition, the electrode comprises a sheet resistance from about 5 Ω/sq to about 0.5 Ω/sq.

According to a second embodiment, the first embodiment is provided wherein the electrode comprises a reflectivity of about 10% or less at the ultraviolet wavelength within the range of 100 nm to 400 nm.

According to a third embodiment, the first embodiment is provided wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

According to a fourth embodiment, any one of the first through the third embodiments is provided wherein each of the electrically conductive structure and the at least one metal layer of the optical absorber structure is, independently, selected from the group consisting of Cr, Mo, Au, Ag, Ni, Ti, Cu, Al, a Ni/Au alloy, a Au/Si alloy, Zr, V, a Cu/Ni alloy, other alloys thereof, and combinations thereof.

According to a fifth embodiment, any one of the first through the fourth embodiments is provided wherein each of the at least two metal oxide layers comprises a resistivity of less than 1E-2 Ωcm.

According to a sixth embodiment, any one of the first through the fifth embodiments is provided wherein each of the at least two metal oxide layers comprises a thickness from about 20 nm to about 60 nm, each of the at least one metal layer of the optical absorber structure comprises a thickness from about 2 nm to about 20 nm, and the electrically conductive structure comprises a thickness from about 30 nm to about 200 nm.

According to a seventh embodiment, any one of the first through the sixth embodiments is provided that includes: a second substrate disposed on the optical absorber structure of the electrode; and a bond defined at least in part by the electrode. The bond hermetically seals the first substrate and the second substrate. The bond comprises an optical transmittance of at least 70% at an infrared wavelength within a range of 800 nm to 1.7 μm.

According to an eighth embodiment, the fifth embodiment is provided wherein each of the metal oxide layers comprises, independently, a transparent conductive oxide (TCO) selected from the group consisting of indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof.

According to a ninth embodiment of the disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 555 nm to 620 nm, and a reflectivity of about 25% or less at an ultraviolet wavelength within a range of 100 nm to 400 nm. The absorber structure comprises at least two metal oxide layers and at least one metal layer, each metal layer between two of the metal oxide layers, and further wherein the electrode comprises a sheet resistance from about 5 Ω/sq to about 0.5 Ω/sq.

According to a tenth embodiment, the ninth embodiment is provided wherein the electrode comprises a reflectivity of about 10% or less at the ultraviolet wavelength within the range of 100 nm and 400 nm.

According to an eleventh embodiment, the ninth embodiment is provided wherein the electrode comprises a reflectivity minimum of about less than about 1% at a visible wavelength within a range of 550 nm to 620 nm, and a reflectivity of about 5% or less at an ultraviolet wavelength within a range of 100 nm and 400 nm.

According to a twelfth embodiment, any one of the ninth through the eleventh embodiments is provided wherein each of the electrically conductive structure and the at least one metal layer of the optical absorber structure is, independently, selected from the group consisting of Cr, Mo, Au, Ag, Ni, Ti, Cu, Al, a Ni/Au alloy, a Au/Si alloy, Zr, V, a Cu/Ni alloy, other alloys thereof, and combinations thereof.

According to a thirteenth embodiment, any one of the ninth through the twelfth embodiments is provided wherein each of the at least two metal oxide layers of the absorber structure comprises a resistivity of less than 1E-2 Ω·cm.

According to a fourteenth embodiment, any one of the ninth through the thirteenth embodiments is provided wherein each of the at least two metal oxide layers comprises a thickness from about 20 nm to about 60 nm, each of the at least one metal layer of the optical absorber structure comprises a thickness from about 2 nm to about 20 nm, and the electrically conductive structure comprises a thickness from about 30 nm to about 200 nm.

According to a fifteenth embodiment, any one of the ninth through the fourteenth embodiments is provided which includes: a second substrate disposed on the optical absorber structure of the electrode; and a bond defined at least in part by the electrode. The bond hermetically seals the first substrate and the second substrate, and further wherein the bond comprises an optical transmittance of at least 70% at an infrared wavelength within a range of 800 nm to 1.7 μm.

According to a sixteenth embodiment, any one of the ninth through the fifteenth embodiments is provided wherein the electrode comprises a sheet resistance from about 3 Ω/sq to about 0.5 Ω/sq.

According to a seventeenth embodiment, the thirteenth embodiment is provided wherein each of the metal oxide layers comprises, independently, a transparent conductive oxide (TCO) selected from the group consisting of indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof.

According to an eighteenth embodiment, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 555 nm to 620 nm, and a reflectivity of about 25% or less at an ultraviolet wavelength within a range of 100 nm to 400 nm. The absorber structure comprises at least two conductive dielectric layers and at least one metal layer, each metal layer between two of the conductive dielectric layers, and the electrode comprises a sheet resistance from about 5 Ω/sq to about 0.5 Ω/sq, and each of the at least two conductive dielectric layers of the absorber structure comprises a resistivity of less than about 1E-2 Ω·cm and a band gap of at least about 3.5 eV.

According to a nineteenth embodiment, the eighteenth embodiment is provided wherein the electrode comprises a reflectivity of about 10% or less at the ultraviolet wavelength within the range of 100 nm to 400 nm.

According to a twentieth embodiment, the eighteenth embodiment is provided wherein the electrode comprises a reflectivity minimum of about 1% or less at a visible wavelength within a range of 390 nm to 700 nm, and a reflectivity of about 5% or less at the ultraviolet wavelength within the range of 100 nm and 400 nm.

According to a twenty-first embodiment, any one of the eighteenth through the twentieth embodiments is provided wherein each of the electrically conductive structure and the at least one metal layer of the optical absorber structure is, independently, selected from the group consisting of Cr, Mo, Au, Ag, Ni, Ti, Cu, Al, a Ni/Au alloy, a Au/Si alloy, Zr, V, a Cu/Ni alloy, other alloys thereof, and combinations thereof.

According to a twenty-second embodiment, any one of the eighteenth through the twenty-first embodiments is provided wherein each of the at least two conductive dielectric layers comprises a thickness from about 20 nm to about 60 nm, each of the at least one metal layer of the optical absorber structure comprises a thickness from about 2 nm to about 20 nm, and the electrically conductive structure comprises a thickness from about 30 nm to about 200 nm.

According to a twenty-third embodiment, any one of the eighteenth through the twenty-second embodiments is provided that include: a second substrate disposed on the optical absorber structure of the electrode; and a bond defined at least in part by the electrode. The bond hermetically seals the first substrate and the second substrate, and the bond comprises an optical transmittance of at least 70% at an infrared wavelength within a range of 800 nm to 1.7 μm.

According to a twenty-fourth embodiment, the twenty-third embodiment is provided wherein each of the conductive dielectric layers comprises, independently, a transparent conductive oxide (TCO) selected from the group consisting of indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof.

According to a twenty-fifth embodiment, a liquid lens is provided that includes: a first substrate; an electrode disposed on a primary surface of the first substrate and comprising an electrically conductive structure disposed on the primary surface of the first substrate and an optical absorber structure disposed on the electrically conductive structure; a second substrate disposed on the absorber structure of the electrode; a bond defined at least in part by the electrode. The bond hermetically seals the first substrate and the second substrate; a cavity defined at least in part by the bond; and a first liquid and a second liquid disposed within the cavity. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. The absorber structure comprises at least two metal oxide layers and at least one metal layer, each metal layer between two of the metal oxide layers, and the first liquid and the second liquid are substantially immiscible such that an interface between the first liquid and the second liquid defines a lens of the liquid lens.

According to a twenty-sixth embodiment, the twenty-fifth embodiment is provided wherein the electrode comprises a sheet resistance from about 5 Ω/sq to about 0.5 Ω/sq.

According to a twenty-seventh embodiment, the twenty-fifth or twenty-sixth embodiment is provided wherein each of the electrically conductive structure and the at least one metal layer of the optical absorber structure is, independently, selected from the group consisting of Cr, Mo, Au, Ag, Ni, Ti, Cu, Al, a Ni/Au alloy, a Au/Si alloy, Zr, V, a Cu/Ni alloy, other alloys thereof and combinations thereof, wherein each of the at least two metal oxide layers of the absorber structure comprises, independently, a transparent conductive oxide (TCO) selected from the group consisting of indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof.

According to a twenty-eighth embodiment, any one of the twenty-fifth through the twenty-seventh embodiments is provided wherein each of the at least two metal oxide layers comprises a thickness from about 20 nm to about 60 nm, each of the at least one metal layer of the absorber structure comprises a thickness from about 2 nm to about 20 nm, and the electrically conductive structure comprises a thickness from about 30 nm to about 200 nm.

According to a twenty-ninth embodiment, any one of the twenty-fifth through the twenty-eighth embodiments is provided wherein the bond comprises an optical transmittance of at least 70% at an infrared wavelength within a range of 800 nm to 1.7 μm.

According to a thirtieth embodiment, a liquid lens is provided that includes: a first substrate; an electrode disposed on a primary surface of the first substrate; a second substrate disposed on the electrode; a bond defined at least in part by the electrode, wherein the bond hermetically seals the first substrate and the second substrate; a cavity defined at least in part by the bond; and a first liquid and a second liquid disposed within the cavity. The first liquid and the second liquid are substantially immiscible such that an interface between the first liquid and the second liquid defines a lens of the liquid lens. The electrode comprises a reflectivity minimum of about 3% or less at a visible wavelength within a range of 390 nm to 700 nm, a reflectivity of about 25% or less at an ultraviolet wavelength within a range of 100 nm to 400 nm, and a sheet resistance from about 5 Ω/sq to about 0.5 Ω/sq, and the bond comprises an optical transmittance of at least about 70% at an infrared wavelength within a range of 800 nm to 1.7 μm.

According to a thirty-first embodiment, the thirtieth embodiment is provided wherein the electrode comprises a reflectivity of about 10% or less at the ultraviolet wavelength within the range of 100 nm to 400 nm.

According to a thirty-second embodiment, the thirtieth or thirty-first embodiment is provided wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. An article, comprising:
a first substrate; and
an electrode disposed on a primary surface of the first substrate,
the electrode comprising an electrically conductive structure disposed on the primary surface of the first substrate and an optical absorber structure disposed on the electrically conductive structure,
a second substrate disposed on the optical absorber structure of the electrode; and
a bond defined at least in part by the electrode,
wherein the electrode comprises a reflectivity minimum of about 3% or less at a visible wavelength within a range of 390 nm to 700 nm, and a reflectivity of about 25% or less at an ultraviolet wavelength within a range of 100 nm to 400 nm, and
further wherein the absorber structure comprises at least two metal oxide layers and at least one metal layer, each metal layer between two of the metal oxide layers.

2. The article according to claim 1, wherein the electrode comprises a reflectivity of about 10% or less at the ultraviolet wavelength within the range of 100 nm to 400 nm.

3. The article according to claim 1, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

4. The article according to claim 1, wherein each of the electrically conductive structure and the at least one metal layer of the optical absorber structure is, independently, selected from the group consisting of Cr, Mo, Au, Ag, Ni, Ti, Cu, Al, a Ni/Au alloy, a Au/Si alloy, Zr, V, a Cu/Ni alloy, other alloys thereof, and combinations thereof.

5. The article according to claim 1, wherein each of the at least two metal oxide layers comprises a resistivity of less than 1E-2 Ω·cm.

6. The article according to claim 1, wherein each of the at least two metal oxide layers comprises a thickness from about 20 nm to about 60 nm, each of the at least one metal layer of the optical absorber structure comprises a thickness from about 2 nm to about 20 nm, and the electrically conductive structure comprises a thickness from about 30 nm to about 200 nm.

7. The article according to claim 1,
wherein the bond comprises an optical transmittance of at least 70% at an infrared wavelength within a range of 800 nm to 1.7 μm.

8. The article according to claim 1,
wherein each of the metal oxide layers comprises, independently, a transparent conductive oxide (TCO) selected from the group consisting of indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof.

9. The article according to claim 1, wherein:
the electrode comprises a reflectivity minimum of about 3% or less at a visible wavelength within a range of 555 nm to 620 nm, and
the electrode comprises a sheet resistance from about 5 Ω/sq to about 0.5 Ω/sq.

10. (canceled)

11. The article according to claim 1, wherein the electrode comprises a reflectivity minimum of about less than about 1% at a visible wavelength within a range of 550 nm to 620 nm, and a reflectivity of about 5% or less at an ultraviolet wavelength within a range of 100 nm and 400 nm.

12-15. (canceled)

16. The article according to claim 1, wherein the electrode comprises a sheet resistance from about 3 Ω/sq to about 0.5 Ω/sq.

17. (canceled)

18. The article according to claim 1, wherein:
the electrode comprises a sheet resistance from about 5 Ω/sq to about 0.5 Ω/sq, and
each of the at least two conductive dielectric layers of the absorber structure comprises a resistivity of less than about 1E-2 Ω·cm and a band gap of at least about 3.5 eV.

19-24. (canceled)

25. A liquid lens, comprising:
a first substrate;
an electrode disposed on a primary surface of the first substrate and comprising an electrically conductive structure disposed on the primary surface of the first substrate and an optical absorber structure disposed on the electrically conductive structure;
a second substrate disposed on the absorber structure of the electrode;
a bond defined at least in part by the electrode, wherein the bond hermetically seals the first substrate and the second substrate;
a cavity defined at least in part by the bond; and
a first liquid and a second liquid disposed within the cavity,
wherein the electrode comprises a reflectivity minimum of about 3% or less at a visible wavelength within a range of 390 nm to 700 nm, and a reflectivity of about 25% or less at an ultraviolet wavelength within a range of 100 nm to 400 nm,
wherein the absorber structure comprises at least two metal oxide layers and at least one metal layer, each metal layer between two of the metal oxide layers, and
further wherein the first liquid and the second liquid are substantially immiscible such that an interface between the first liquid and the second liquid defines a lens of the liquid lens.

26. The liquid lens according to claim 25, wherein the electrode comprises a sheet resistance from about 5 Ω/sq to about 0.5 Ω/sq.

27. The liquid lens according to claim 25,
wherein each of the electrically conductive structure and the at least one metal layer of the optical absorber structure is, independently, selected from the group consisting of Cr, Mo, Au, Ag, Ni, Ti, Cu, Al, a Ni/Au alloy, a Au/Si alloy, Zr, V, a Cu/Ni alloy, other alloys thereof and combinations thereof,
wherein each of the at least two metal oxide layers of the absorber structure comprises, independently, a transparent conductive oxide (TCO) selected from the group consisting of indium tin oxide (ITO), aluminum-doped zinc oxide (AZO), gallium-doped zinc oxide (GZO), boron-doped zinc oxide (BZO), fluorine-doped tin oxide (FTO), zinc tin oxide (ZTO), titanium niobium oxide (TNO), indium gallium zinc oxide (IGZO), and combinations thereof.

28. The liquid lens according to claim 25, wherein each of the at least two metal oxide layers comprises a thickness from about 20 nm to about 60 nm, each of the at least one metal layer of the absorber structure comprises a thickness from about 2 nm to about 20 nm, and the electrically conductive structure comprises a thickness from about 30 nm to about 200 nm.

29. The liquid lens according to claim 25, wherein the bond comprises an optical transmittance of at least 70% at an infrared wavelength within a range of 800 nm to 1.7 μm.

30. A liquid lens, comprising:
a first substrate;
an electrode disposed on a primary surface of the first substrate;
a second substrate disposed on the electrode;
a bond defined at least in part by the electrode, wherein the bond hermetically seals the first substrate and the second substrate;
a cavity defined at least in part by the bond; and
a first liquid and a second liquid disposed within the cavity,
wherein the first liquid and the second liquid are substantially immiscible such that an interface between the first liquid and the second liquid defines a lens of the liquid lens,
wherein the electrode comprises a reflectivity minimum of about 3% or less at a visible wavelength within a range of 390 nm to 700 nm, a reflectivity of about 25% or less at an ultraviolet wavelength within a range of 100 nm to 400 nm, and a sheet resistance from about 5 Ω/sq to about 0.5 Ω/sq, and
further wherein the bond comprises an optical transmittance of at least about 70% at an infrared wavelength within a range of 800 nm to 1.7 μm.

31. The liquid lens according to claim 30, wherein the electrode comprises a reflectivity of about 10% or less at the ultraviolet wavelength within the range of 100 nm to 400 nm.

32. The liquid lens according to claim 30, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.
